(19) United States
(12) Patent Application Publication
(10) Pub. No.: US 2008/0270286 A1
(43) Pub. Date: Oct. 30, 2008

(54) PRODUCT EXCHANGE SYSTEMS AND METHODS

(75) Inventors: Darian L. WILSON, (US); Andrew M. CEFAI, Tokyo (JP); Jacob P. GOLDBLATT, Los Angeles, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: IPO 2.0 LLC, Los Angeles, CA (US)

(21) Appl. No.: 12/107,529

(22) Filed: Apr. 22, 2008

Related U.S. Application Data
(60) Provisional application No. 60/992,062, filed on Dec. 3, 2007.
(60) Provisional application No. 60/914,683, filed on Apr. 27, 2007.

(51) Int. Cl. G06Q 40/00

(52) U.S. Cl. 705/37

(57) ABSTRACT

Embodiments disclosed herein generally relate to a global network-based trading exchange. In embodiments, the trading exchange trades both products, product concepts and ownership shares associated with the products and product concepts both as ownership shares and as bundled offerings. For example, the products offered are downloadable electronic files, such as music downloads or movie downloads. A user can buy ownership shares or the bundled offering and then own the rights to dividends in the future sales of the product. Further, the user may trade the shares on the trading exchange. In embodiments, the determination of the price for the shares and/or bundled offering is dynamic and fluctuates with market demand.

### CROSS-REFERENCES TO RELATED APPLICATIONS

This application is related to and claims priority from: co-pending U.S. Provisional Patent Application No. 60/992,062, filed Dec. 3, 2007 and entitled “GLOBAL MUSIC STOCK EXCHANGE, SYSTEMS AND METHODS”;” and related to U.S. Provisional Patent Application No. 60/914,683, filed Apr. 27, 2007 and entitled “SYSTEM AND METHOD TO ENCOURAGE AND PROMOTE COMMUNITY-OWNERSHIP OF MUSIC THROUGH THE USE OF A GLOBAL MUSIC STOCK EXCHANGE;” and U.S. patent application Ser. No. ______, Attorney Docket No. 026960-000210US, filed concurrently herewith, entitled “PRODUCT STOCK EXCHANGE.” The disclosure of the foregoing applications are hereby incorporated by reference as if set forth in full in this document, for all purposes.

### BACKGROUND

There is currently significant uncertainty in the music industry due to the widespread practice of illegal music downloading from the Internet and a resultant decline in legal compact disc (CD) and music download sales. Generally, once a song or album is downloaded, the producer or distributor loses control of the distribution of the song or album. While copyright laws generally prohibit the redistribution of the songs or albums, some people continue to redistribute or share music online.

To combat this illegal music sharing, music industry companies and representatives have been forced to sue the music file sharers. Unfortunately, the legal situation requires the music companies to sue the very customers to which they are trying to sell. Thus, some organizations and companies have been trying to find electronic or software systems that prohibit file sharing. For example, a lock may be embedded into the digital file of a downloaded song that prevents the digital file from being copied. Unfortunately, these efforts are routinely undermined by hackers that distribute workarounds on the Internet.

Recently, there have been other organizations that have been trying a different approach to the file sharing business. There exist platforms and services that generally relate to online trading. One such service, http://www.amiestreet.com/, prices songs based on user demand. Another similar service is http://www.sellaband.com, which sells shares in a band. A relatively new service, http://www.kinooga.com/, operates in a manner similar to http://www.sellaband.com. There are other exchanges that trade in other products, such as http://www.liv-ex.co.uk, which trades in wine. For all these sites, there still remains no liquidity of the investment in the products. As such, the purchases tend to be long-term investments that yield little money. Further, the investments provide no valuation if the product becomes increasingly popular.

It is in consideration of these and other factors that the present patent application is being presented.

### SUMMARY

Embodiments disclosed herein generally relate to a global network-based trading exchange. In embodiments, the trading exchange utilizes a formula, an algorithm, or an alternate process or method for determining share pricing. For example, the exchange uses an auction system to control the price of shares in music downloads and other product and/or product concept offerings. An exemplary auction system may include Trading Rules, known in the industry.

In embodiments, Product Owners (for example, music labels, independent artists, other creative persons, content owners, product owners, and/or distributors) upload and/or provide products (for example, music downloads, music streams, CDs, digital video discs (DVD), concert tickets, etc.) to be sampled, sold, and traded on the global network-based trading exchange. Further, the Product Owners, in embodiments, offer potential Customers and Users the opportunity to purchase a revenue share agreement that can, in embodiments, be bundled together with the product and/or products being purchased.

Advantageously, embodiments described herein provide the ability to trade in investments in the products or product concepts and share in revenues from a class of products or product concepts that traditionally have not been offered and traded on an open trading exchange platform in two locations. Other embodiments bundle the sale of a product and the investment in the product. As such, a purchaser can share future revenues of the product without having to invest in the product separately. The bundled offering makes it easier for Users to enter into agreements with Product Owners for such revenue share agreements. Alternative embodiments allow Product Owners to set a premium price for a product in relation to the product's perceived and actual value of the bundled revenue share agreement. Thus, the price of investment is dynamic and reflects market conditions.

This Summary only provides a description of some embodiments and is not meant to limit the scope of the invention in any manner or form. The invention is defined only by the claims attached hereto.

### BRIEF DESCRIPTION OF THE DRAWINGS

FIG. 1 is a block diagram of an embodiment of a global product trading exchange system.

FIG. 2A is a functional block diagram of an embodiment of a user server.

FIG. 2B is a functional block diagram of an embodiment of a product owner server.

FIG. 2C is a functional block diagram of an embodiment of a banking server.

FIG. 3 is an exemplary web page for an embodiment of a revenue sharing agreement.

FIG. 4 is an exemplary web page for an embodiment of a product trade exchange.

FIG. 5 is an exemplary web page for an embodiment of a product share trade exchange.

FIG. 6 is a flow diagram of an embodiment of a method for purchasing a bundled offering.

FIG. 7 is a flow diagram of an embodiment of a method for receiving a product to be offered for sale.

FIG. 8 is block diagram of an embodiment of a business intelligence system.

FIG. 9 is block diagram of an embodiment of a computer system operable to function in the systems described herein.

FIG. 10 is a block diagram of an embodiment of a networked system of computers operable to function in the systems described herein.

### DETAILED DESCRIPTION

Embodiments described herein provide methods and systems to offer, purchase and trade in shares of products (for example, downloadable music files) or product concepts, wherein the shares can be acquired separately or automatically acquired in conjunction with the purchase of music or other products. In embodiments, a product owner offers the product or product concept and creates a revenue sharing agreement. The revenue sharing agreement can document how shares are provided to a user that purchases the product or shares in the product or product concept. The shares give the user an interest in the product or product concept, such that the user can receive dividends from future sales or can trade the shares for a monetary value. When buying the product, the user, in embodiments, is automatically provided the shares according to the revenue sharing agreement.

While various embodiments are summarized above, the following detailed description illustrates exemplary embodiments in further detail to enable one of skill in the art to practice the various embodiments. In the following description, for the purposes of explanation, numerous specific details are set forth in order to provide a thorough understanding of the embodiments. It will be apparent, however, to one skilled in the art that alternative embodiments may be practiced without some of these specific details.

In other instances, well-known structures and devices are shown in block diagram form. Several embodiments are described below, and while various features are ascribed to different embodiments, it should be appreciated that the features described with respect to one embodiment may be incorporated with another embodiment as well. By the same token, however, no single feature or features of any described embodiment should be considered essential, as other embodiments may omit such features.

### Exemplary Embodiments

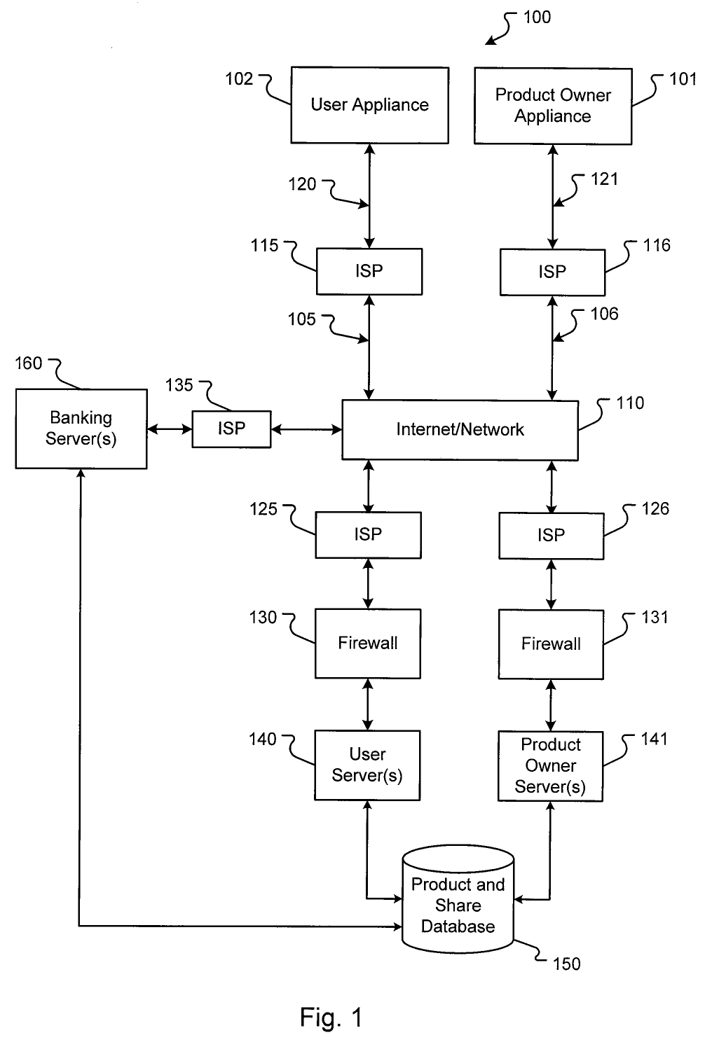

An embodiment of a global product trading exchange system 100 is shown in FIG. 1. The global product trading exchange system 100, in embodiments, allows one or more product owners to offer bundled product and ownership shares in the product and allows users to purchase and trade the shares in the product. In embodiments, the system 100 comprises a banking server 160, one or more product owner servers 141, and/or one or more user servers 140. The components of the system 100 communicate with each other through a network 110 and one or more information appliances (for example, user appliance 102, product owner appliance 101, internet service providers 115, 116, 125, 135, and/or 126, and firewalls 130 and/or 131).

It should be noted that the arrangement of the system 100 in FIG. 1 is intended to be exemplary in nature, and that other arrangements are possible in accordance with various embodiments. Similarly, while the description below ascribes certain functionality to various components of the system 100, it should be appreciated that, in other embodiments, such functionality could be provided by different components. Merely by way of example, the collective functionality ascribed to two or more components could be incorporated within a single component; similarly, the functionality ascribed to a single component could be divided among multiple components.

The individual client information appliances 102 and/or 101 can include, without limitation, PCs, wireless devices, etc., capable of communicating with a server. Information appliances 102 and/or 101 can access a service provider, such as an Internet Service Provider (ISP) 115, either directly or via a network connection 120 and/or 121. In general, the system 100 may be used in conjunction with any suitable information appliance device 102 and/or 101 that is capable of communicating with other components of a communications network, such as a network server, and which include the necessary interfaces for inputting information, viewing presented information, and selecting and otherwise manipulating presented information.

As described above, client information appliances 102 and/or 101 may be, for example, commercially available general purpose computer hardware such as personal computers, equipped with a desktop browser that enables the user to access the Internet. Each client information appliance 102 and/or 101, in embodiments, has an associated communications link 120 and/or 121, respectively, to connect the client information appliance to a service provider, such as an Internet Service Provider (ISP) 115 and/or 116. In FIG. 1, each client information appliance 102 and/or 101 is shown as being connected to a unique ISP 115 and/or 116. It should be noted that multiple user client information appliances 102 may be connected to the same ISP 115 and multiple product owner client information appliances 101 may be connected to the same ISP 116. Additionally, ISPs 115 and/or 116 may be the same service providers. In embodiments, communications links 105 and/or 106 connect the ISP 115 and/or 116 to the network 110. Each client information appliance 102 and/or 101 can transmit and receive data from the network 110 through its ISP 115 and/or 116.

Network 110 is any network of inter-connected information appliance devices. In embodiments, network 110 is a local area network (LAN), wide area network (WAN), or the Internet. The network 110, in embodiments, is the Internet with World-Wide-Web capabilities, allowing access to information and services by using hypertext to organize, search and present information to users.

From a hardware standpoint, in one embodiment, servers 160, 140 and/or 141 will typically contain one or more components, such as one or more microprocessors, for performing the operations required for program operation. A server computer 160, 140 and/or 141 may also typically contain disk storage media, such as one or more disk drives for program and data storage, and a random access memory, for temporary data and program instructions. The servers 160, 140 and/or 141 can be a single server computer system or two or more server computer systems operating in conjunction to perform the operations described herein. In embodiments, the servers 160, 140 and/or 141 are connected to the Internet 110 via one or more ISPs 135, 125, and/or 126, respectively.

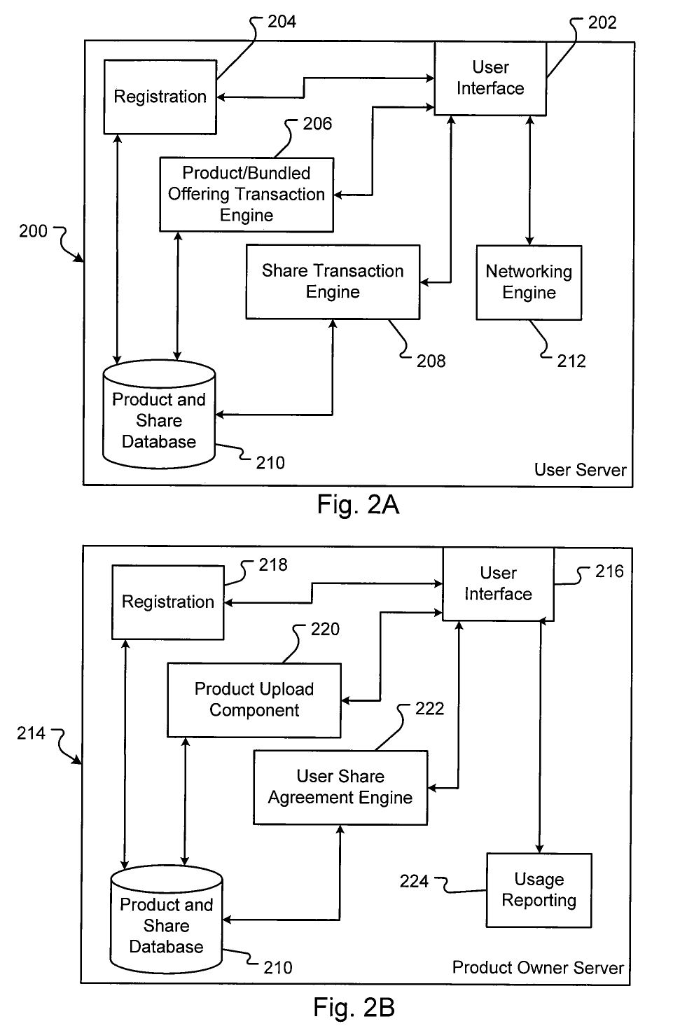

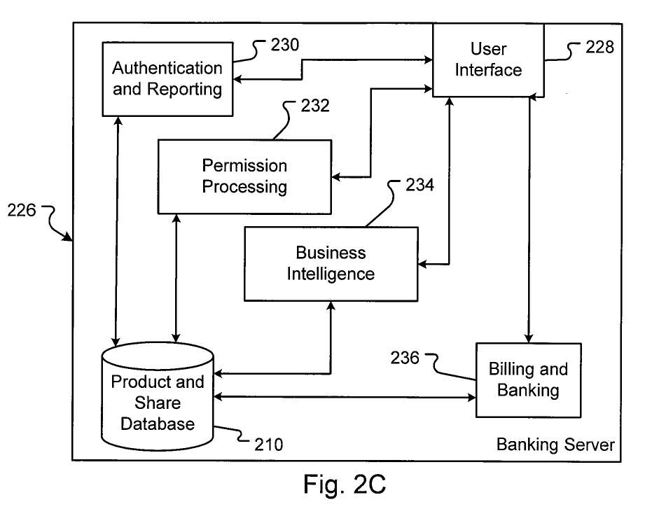

The servers 140 and/or 141 may also be connected to the Internet through a firewall 130 and/or 131. A firewall 130 and/or 131 may provide a security platform that prevents unauthorized access to the servers 140 and/or 141. An embodiment of the user server 140 is described in conjunction with FIG. 2A and an embodiment of the product owner server 141 is described in conjunction with FIG. 2B. Further, an embodiment of the banking server 160 is described in conjunction with FIG. 2C.

In embodiments, servers 160, 140 and/or 141 are connected to a database 150. The database 150 may be one or more storage devices operable to store data. For example, the database 150 is a disc storage array. The storage media may be controlled or managed by a database management system. In one embodiment, the database is a relational database. One or more items of data about products offered for sale, about shares sold or owned, and/or other business intelligence is stored on the database 150. The servers 160, 140 and/or 141 can communicate with the database to store or access the information.

An embodiment of a user server 200 is shown in FIG. 2A. In embodiments, the user server 200 is the same or similar to user server 140. The user server 200 may comprise one or more components. The components, in embodiments, are one or more software components having instructions to execute one or more computer-executable methods described herein. The software may be resident on the disc media storage, which, when executed, directs the server to perform their data transmission and reception functions. In embodiments, the user server 200 comprises a registration component 204, a product/bundled offering transaction engine 206, a share transaction engine 208, a networking engine 212, and/or a user interface 202. A product and share database 210, similar or the same as product and share database 150 (FIG. 1), may also be a part of the user server 200 but may also be a separate device accessible by the user server 200.

The user server 200 software allows a user appliance 102 (FIG. 1) to interface with the global network-based trading exchange platform 100 (FIG. 1) through the user interface 202. The user interface 202 can provide one or more web pages that are rendered by the user appliance 102 (FIG. 1). The user, in embodiments, buys products, trades shares, gathers business intelligence, and completes other activities through the web pages created by the user interface 202.

A registration component 204, in embodiments, allows a user to register with the global network-based trading exchange to buy products, trade shares, gather business intelligence, and complete other activities. To register, a user inputs information into the registration component 204, for example, name, address, email, and username. The registration component 204 may then store the information in the product and share database 210. In alternative embodiments, the registration component 204 also receives the acceptance from the user of the revenue share agreement for buying and trading shares of the product.

A product/bundled offering transaction engine 206 may provide for the purchase of products. In embodiments, the product/bundled offering transaction engine 206 reads information about one or more products, and possibly, one or more revenue share agreements, from the product and share database 210. The information about the products and revenue share agreements is provided to the user interface 202 to present to the user. The user may purchase the product from the product/bundled offering transaction engine 206. The product/bundled offering transaction engine 206 may then send or allow the user to download the product from the product and share database 210. In alternative embodiments, the product/bundled offering transaction engine 206 also provides the shares to the user.

In embodiments, a share transaction engine 208 provides a system to buy and sell shares in the products the user has purchased. The trading of shares may be based on the terms and conditions of the revenue share agreement. In embodiments, the share transaction engine 208 can provide a system to the user interface 202 to present one or more web pages where the user can trade shares. The share transaction engine 208 can read information about share price, volume, and other information from the product and share database 210. Further, the share transaction engine 208 can store information to the product and share database 210.

Software in the share transaction engine 208, in embodiments, allows the user to continue to buy and sell shares, match bids on a priority basis, store bids in a priority queue, report final sales of a particular transaction, execute buy and sell orders of a share for which the bid and offer have been matched and approved, confirm the execution of an approved trade to both buyers and sellers for bids and offers that are matched, and create and manage user accounts. The share transaction engine 208 may also detect, with a compliance system (not shown), unauthorized trades of the product and disbar those users from performing the unauthorized trades of the products. In embodiments, the share transaction engine 208 transmits details of the above transactions to the user's information appliances 102 (FIG. 1) via network 110 (FIG. 1) and associated communication links.

A networking engine 212, in embodiments, allows a user to engage in social networking services. For example, a user may communicate with the user server 200 to create a personalized homepage, to write a blog, to upload photos, and/or to participate in an affiliate program. In embodiments, the user can communicate with other music share traders using a communication system offered by the networking engine 212. For example, the networking engine 212 provides an email system, a blog, and/or an instant messaging system.

In embodiments, the networking engine 212 provides a customer loyalty program. The user can be provided an identifier, e.g., a loyalty customer number, which may be listed on a loyalty card or other media. When the user purchases a product or share, the user may enter his or her loyalty identifier. The networking engine 212, in embodiments, assigns some value to the an account associated with the identifier. The value may be monetary or be some other form of value. For example, the networking engine 212 assigns a predetermined number of loyalty points to the customer's loyalty account having the identifier. The networking engine 212 may include an account for the customer in the product and share database 210 and store the value information in the product and share database 210. After reaching some predetermined threshold, the customer may use the points or value to obtain a product, a share, or some other reward.

An embodiment of a product owner server 214 is shown in FIG. 2B. In embodiments, the product owner server 214 is the same or similar to product owner server 141. The product owner server 214 may comprise one or more components. The components, in embodiments, are one or more software components having instructions to execute one or more computer-executable methods described herein. The software may be resident on the disc media storage, which, when executed, directs the server to perform their data transmission and reception functions. In embodiments, the product owner server 214 comprises a registration component 218, a product upload component 220, a user share agreement engine 222, a usage reporting component 224, and/or a user interface 216. A product and share database 210, similar or the same to product and share database 150 (FIG. 1), may also be a part of the product owner server 214 but may also be a separate device accessible by the product owner server 214.

The product owner server 214 software allows a product owner appliance 101 (FIG. 1) to interface with the global network-based trading exchange platform 100 (FIG. 1) through the user interface 216. The user interface 216 can provide one or more web pages that are rendered by the product owner appliance 101 (FIG. 1). The product owner, in embodiments, uploads products, offers shares, provides and gathers business intelligence, and completes other activities through the web pages created by the user interface 216. In alternative embodiments, the user interface 216 provides a database interface for the uploading of products that stores information into the product and share database 210.

A registration component 218, in embodiments, allows a product owner to register with the global network-based trading exchange to sell products, offer shares, provide or gather business intelligence, and completes other activities. To register, a product owner inputs information into the registration component 218, for example, name, address, email, and product owner name. For example, a music company inputs the company's name and address and an email for a point of contact within the company. The registration component 218 may then store the information in the product and share database 210.

The product upload component 220, in embodiments, allows the product owner to upload products. For example, the product owner can upload a music or movie file onto the product owner server 214. In embodiments, the product upload component 220 provides one or more items of data to the user interface 216 to provide an interface to the product owner. The product upload component 220 can store the uploaded products into the product and share database 210. The user server 200 may then access and retrieve the uploaded product from the shared product and share database 210. The product owner, in embodiments, also sets the terms for the sale of the product, e.g., sales price, quantity provided, when the product will be available, etc.

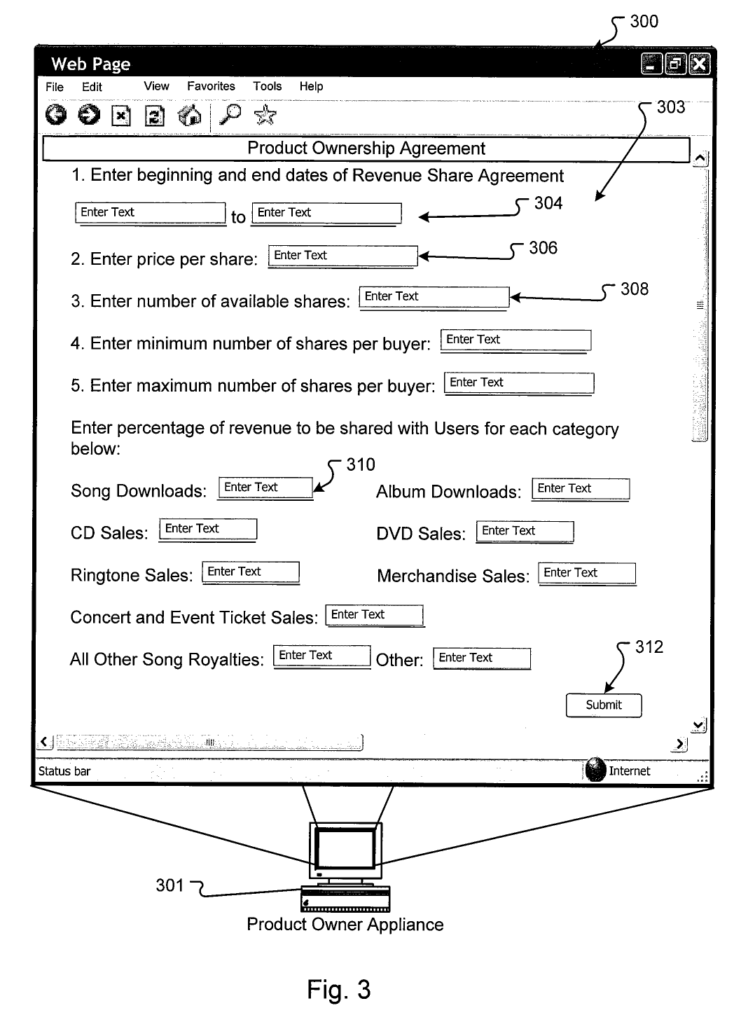

A user share agreement engine 222, in embodiments, accepts a revenue share agreement from the product owner. In embodiments, the user share agreement engine 222 provides information requests to the user interface 216 to solicit the required information to form the revenue share agreement. The user interface 216 can then present an interface to the product owner to receive the information. An exemplary web page presented to the product owner to create the revenue share agreement is as discussed in conjunction with FIG. 3. The user share agreement engine 222 may receive the information and form the revenue share agreement and store the agreement in the product and share database 210. The user server 200 (FIG. 2A) can then retrieve the agreement from the product and share database 210. The information received from the product owner sets the terms and conditions of the revenue share agreement.

In embodiments, a usage reporting component 224 provides information to the product owner. The usage reporting component 224 may communicate with the user interface 216 to provide information to the product owner. The information communicated to the product owner may include sales data, sales trends, shares purchased, share trade volume, highest share price, dividends to be paid, etc. In embodiments, software on the product owner server 214 will track and record each user's buying, selling, and trading activity through the use of persistent cookies placed on the user's individual client information appliance 102 (FIG. 1). In alternative embodiments, the usage reporting component 224 receives information from the product owner. The received information can be provided as business intelligence to the users.

The product owner server 214, in embodiments, provides the products and shares to the user server 200 (FIG. 2A) through the commonly shared product and share database 210. In alternative embodiments, the product owner server 214 provides information in response to calls from the user server 200 (FIG. 2A). In still other embodiments, the user server 200 (FIG. 2A) and the product owner server 214 are integrated into a single server that can receive products for sale and sell the products. Further, the product owner server 214 may communicate with the users to offer the product, shares, or a bundled offering of the product and shares.

An embodiment of a banking server 226 is shown in FIG. 2C. In embodiments, the banking server 226 is the same or similar to banking server 160. The banking server 226 may comprise one or more components. The components, in embodiments, are one or more software components having instructions to execute one or more computer-executable methods described herein. The software may be resident on the disc media storage, which, when executed, directs the server to perform their data transmission and reception functions. The banking server 226, in embodiments, completes more functions than banking or money transfer activity. In embodiments, the banking server 226 comprises an authentication and reporting component 230, a permission processing component 232, a business intelligence component 234, a billing and banking component 236, and/or a user interface 228. A product and share database 210, similar or the same as product and share database 150 (FIG. 1), may also be a part of the banking server 226 but may also be a separate device accessible by the banking server 226.

Authentication and reporting component 230, in embodiments, registers users and/or product owners. After registration of users and/or product owners, the authentication and reporting component 230 can receive a login name and password from the users and/or product owners to access the banking server 226. In alternative embodiments, the authentication and reporting component 230 also controls access to the user server 200 (FIG. 2A) and/or the product owner server 214 (FIG. 2B). The authentication information can also include other data besides a login name and password. For example, a biometric (e.g., a fingerprint), a digital certificate, or other authentication information is sent and verified by the authentication and reporting component 230.

In embodiments, a permission processing component 232 controls the permissions for product owners and users. The permission processing component 232 may gather metadata for shares, products, or business intelligence information to determine whether a product owner or user has access. In embodiments, the permission processing component 232 also stores an identifier for each user and/or product owner. For example, the rules for an offering of a first product from product owner A cannot be changed by product owner B because product owner B would not have permission to make changes to the rules. Likewise, a first user cannot sell a second user's shares. In embodiments, the permission processing component 232 stores authentication information for each user and product owner for the products, shares, or business intelligence associated with each user and product owner. In alternative embodiments, the permission processing component 232 also stores different levels of access for each user and product owner depending on the activity. The permission processing component 232 may also manage content licensing and Digital Rights Management and, thus, enable a secure connection between product owners, rights holders, and distributors based on uniform permission and license codes.

The banking server 226 may also include a billing and banking component 236. The billing and banking component 236 may interface with the user interface 228 to create one or more web pages for interacting with the product owner and user about billing, payment, and banking functions. The data received from the product owner and user may be stored in the product and share database. In embodiments, the billing and banking component 236 uses information obtained from product owners and users to generate billing information for users who have indicated that they would like to purchase a product. The billing and banking component 236 can register product owners and users for accounts, saving the account information to the product and share database 210. Upon activation of an account, the billing and banking component 236 may assign and deposit a persistent mechanism in a browsing program in the client information appliance 102 (FIG. 1), such as a cookie, which in turn transmits billing information back to the billing and banking component 236 during the course of future transactions. The billing and banking component 236 can receive a request for funds transfer from the product owner upon the sale of a product or shares. In embodiments, the billing and banking component 236 transmits a payment request to the user in which the user responds with payment, for example, by a credit card. In other embodiments, the billing and banking component 236 uses the stored billing information to begin an automatic credit card transaction. The billing and banking component 236, in embodiments, completes the credit or other financial transactions. In embodiments, an alternate billing method, such as PayPal, could be used by the billing and banking component 236.

In embodiments, the banking server 226 also includes a business intelligence component 234. The business intelligence component 234, in embodiments, communicates with the user interface 228 to receive business intelligence from the product owners, users, or one or more outside agencies or organizations. The business intelligence may be stored in the product and share database 210 for use by product owners and users. In embodiments, the business intelligence component 234 may gather data from multiple sources, for example, record labels, royalty collecting organizations, music distributors, etc. The business intelligence component 234 may create published business intelligence reports based on extracted, collected, and input data. The reports, in embodiments, contain information about revenue share dividends for product owners and users, share price, share trading volume, etc. The business intelligence component 234 can send the data to the user's and/or product owner's client information appliances 102, 101 (FIG. 1).

An embodiment of a user interface 300 on a product owner appliance 301 is shown in FIG. 3. The user interface 300, in embodiments, includes a web page 303 used by a product owner to set the terms and conditions for a revenue share agreement. Any web page technology which provides a graphical interface for the display and collection of data, through the use of an associated information appliance, and also offers the ability to communicate with a server, is suitable for use in this system. The web page 303 can include an exemplary online questionnaire designed to allow for the input of information by product owner in a simple, efficient and quick manner. For example, the product owner can enter the dates when shares will be offered in text fields 304. Further, the product owner can enter the initial price per share in text field 306 and the number of shares available in text field 308. This information may be stored in the product and share database 210 (FIG. 2A). In other embodiments, the web page 303 also allows the product owner to describe the revenue sharing system. For example, the product owner can enter a percentage of the proceeds from each song purchase to be shared by a user owning a single share. The product owner can enter the information in text field 310. In embodiments, the web page 303 may have a link or button 312 to allow the product owner to confirm that the information is correct.

In embodiments, once the terms and conditions of a particular revenue share agreement have been confirmed by the product owner in the web page 303, a prospectus is generated. The prospectus can be stored in the product and share database 210 (FIG. 2A) for later access. The prospectus can be used by users to evaluate various product and revenue share agreement offerings made by product owners. The prospectus can be made available on another web page, through email, or as a hard copy to be mailed to users.

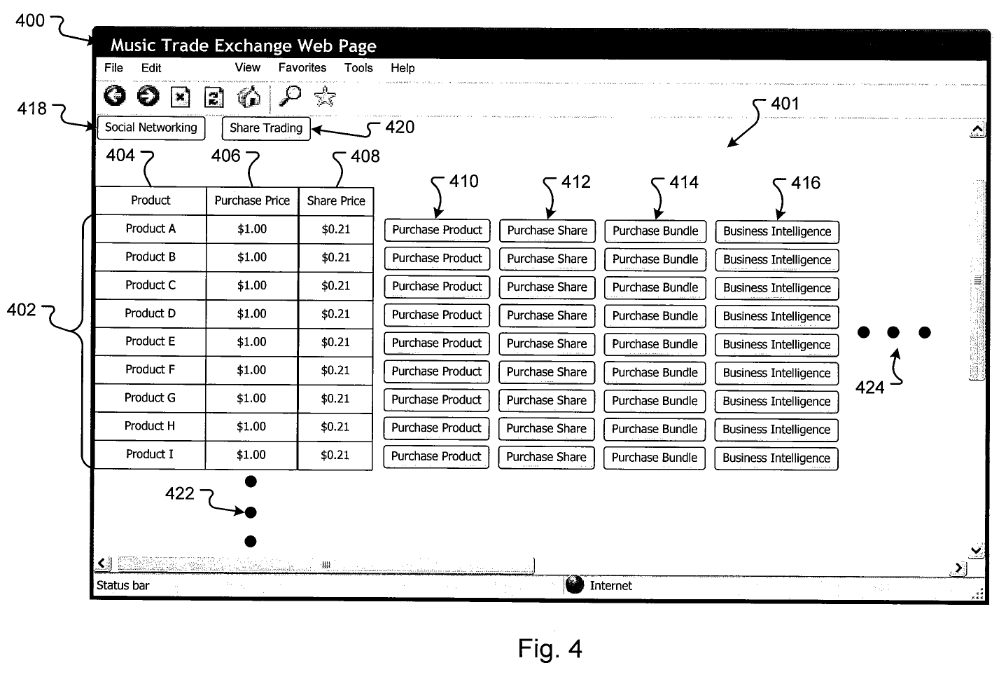

An embodiment of a user interface 400 on a user appliance 102 (FIG. 1) is shown in FIG. 4. The user interface 400, in embodiments, includes a web page 401 used by a user to buy products, shares, enter into revenue share agreements, buy bundled offerings, trade shares, review business intelligence, or enter a social networking site. Any web page technology which provides a graphical interface for the display and collection of data, through the use of an associated information appliance, and also offers the ability to communicate with a server, is suitable for use in this system.

In embodiments, the web page 401 can include one or more products 402, listed in product column 404. There may be less or more products available than those listed as evidenced by ellipses 422. The purchase price for the product may be listed in a purchase price column 406. Similarly, the share prices for a share of the product can be listed in a share price column 408. The share price 408 can be the price of an initial share or the price of the share as currently traded. While the data is shown displayed in a tabular format, any format of display is possible. Other data may also be displayed, for example, the price of a bundled offering, the dates when shares will no longer be sold, the amount of revenue received per share, etc. Any data in the revenue share agreement or that a user may need can be displayed.

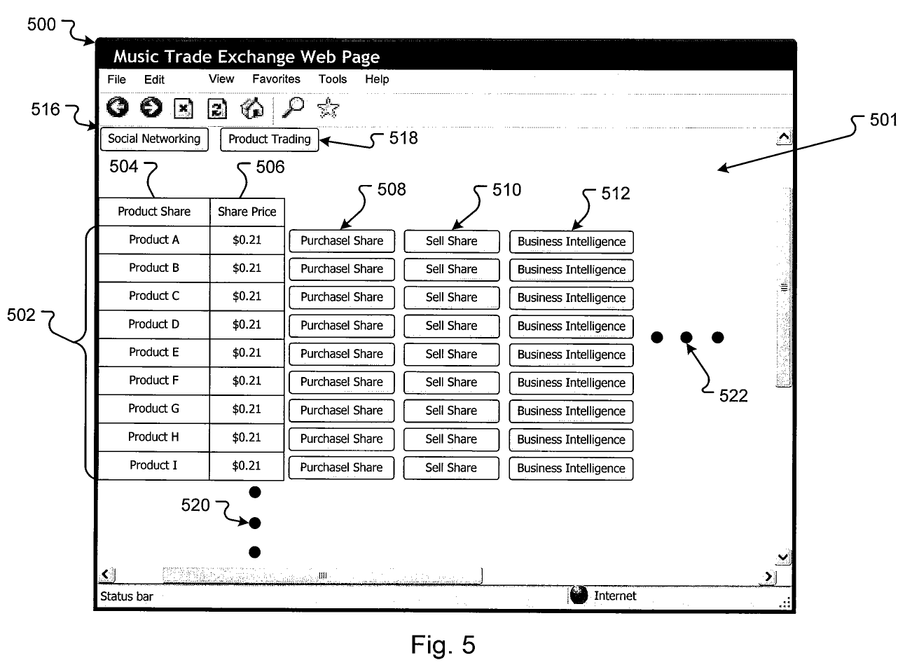

The web page 401, in embodiments, also includes one or more user interface devices. For example, a purchase product button 410 is selected by a user to purchase only the product listed in column 404. Likewise, purchase share button 412 is selected by the user to purchase one or more shares of a product. The purchase bundle button 414 can be selected to purchase a bundled offering of both the product and the shares. Selecting the purchase share button 412 or the purchase bundle button 414 can lead to a user agreeing to a revenue share agreement. A business intelligence button 416 allows a user to view or receive business intelligence information on the product listed in the product column 404. The social networking button 418 may allow a user to enter a social networking site. The user may use the social networking site to create a personalized e-commerce storefront, create a personalized blog, enter contests, games and other events sponsored by product owners and others, participate in the cash rebate program, and/or to join an affiliate program, respectively. Further, the share trading button 420 can allow a user to enter a share trading exchange, as explained in conjunction with FIG. 5. While buttons are shown, any user interface device may be used to receive selections or data from the user. Fewer or more buttons and data may be displayed for each product, as evidenced by ellipses 424.

An embodiment of a user interface 500 on a user appliance 102 (FIG. 1) is shown in FIG. 5. The user interface 500, in embodiments, includes a web page 501 used by a user to trade shares in a product trading exchange. Any web page technology which provides a graphical interface for the display and collection of data, through the use of an associated information appliance, and also offers the ability to communicate with a server, is suitable for use in this system.

In embodiments, the web page 501 can include one or more product shares 502, listed in product share column 504. There may be less or more products available than those listed as evidenced by ellipses 520. The share price, as currently traded for the product share, may be listed in a share price column 506. The share price 506 can be the price of an initial share or the price of the share as currently traded. While the data is shown displayed in a tabular format, any format of display is possible. Other data may also be displayed, for example, the lowest price for a share in the last quarter, the highest price for a share in the last quarter, the volume of trades that day, etc. Any data in the revenue share agreement, generated from business intelligence sources, or generated from the exchange that a user may need can be displayed.

The web page 501, in embodiments, also includes one or more user interface devices. For example, a purchase share button 508 is selected by the user to purchase one or more shares of a product. The sell share button 510 can be selected to sell one or more shares of a product that the user currently owns. Selecting the purchase shares button 508 or the sell share button 510 can lead to a user entering into a sales contract with another user or the product owner for the shares. A business intelligence button 512 allows a user to view or receive business intelligence information on the product or the product share listed in the product share column 504. The social networking button 516 may allow a user to enter a social networking site. Further, the product trading button 518 can allow a user to enter a product purchase web page, as explained in conjunction with FIG. 4. While buttons are shown, any user interface device may be used to receive selections or data from the user. Fewer or more buttons and data may be displayed for each product, as evidenced by ellipses 522.

The mechanisms behind trading systems are generally well-known by those skilled in the art, and embodiments can be configured to execute trades based on generally accepted standards of the share trading industry. In another embodiment, modified trading rules using unique formulas and algorithms, or other processes or methods of determining share pricing can be employed. For example, an auction system may be used for trading. Thus, when a share is available, the user offering the share may receive two or more bids for the share over a predetermined amount of time. At the end of the predetermined amount of time, the user can accept the highest bid. The losing bidder will have to wait until another share is offered. This process will also work if the bids are unsolicited. The nature of the trading system can be flexible and adjusted based on the liquidity of the trading market. The trading system, in embodiments, may perform any of the following functions: validate user information; query orders; match bids and offers; report sales by time, quantity, price and product; report offers as finalized; maintain detailed trade history of one or more users; clear and comply with rules of the system and trading exchange; and provide surveillance for detecting illegal and unauthorized trades.

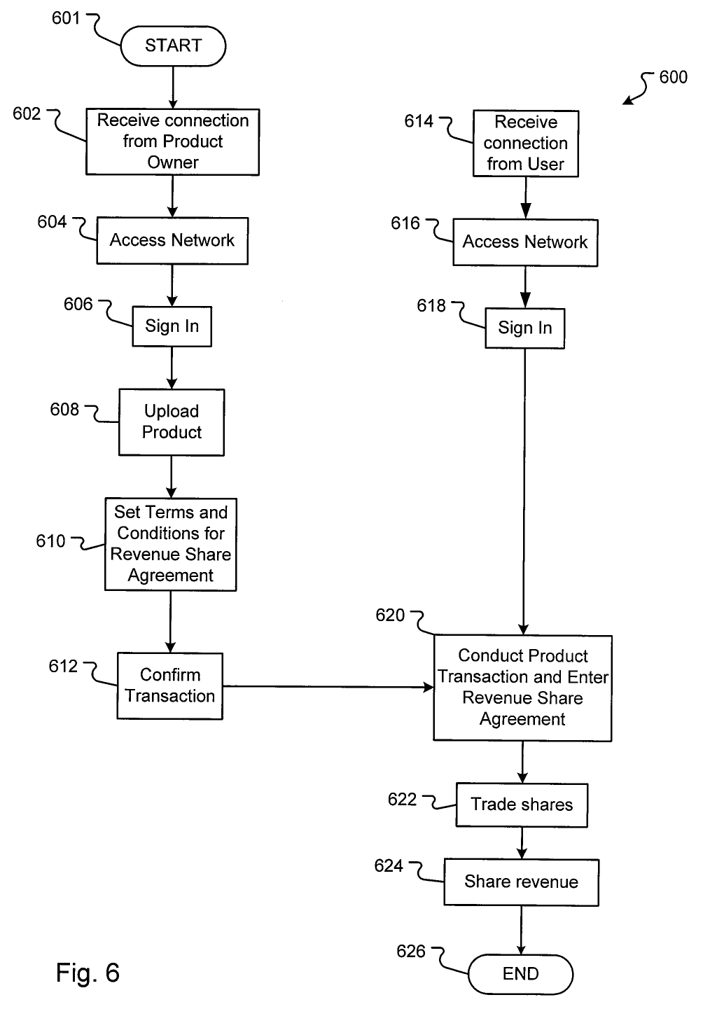

A flow chart of an embodiment of a method 600 for purchasing a bundled offering is shown in FIG. 6. The method 600, in embodiments, represents one or more instructions executable in a computer system for directing the computer system to complete an action. The instructions may be stored on a storage medium and retrieved by the computer system. The method 600, in embodiments, begins with a start operation 601 and terminates with an end operation 626. While a specific order is shown in FIG. 6, the steps may be performed in a different order.

Receive operation 602 receives a connection from the product owner. In embodiments, the product owner begins communication with a product owner server 141 (FIG. 1) using a product owner appliance 101 (FIG. 1). The communication may be the request of a web page using a URL. Access operation 604 accesses the network. In embodiments, the product owner's appliance 101 (FIG. 1) communicates with the ISP 116 (FIG. 1) through link 121 (FIG. 1) to connect with the Internet 110 (FIG. 1). The web request is routed to the ISP 126 (FIG. 1) and to the firewall 131 (FIG. 1).

Sign in operation 606 signs in the product owner. In embodiments, the product owner and the product owner's appliance 101 (FIG. 1) are authenticated. The firewall 131 (FIG. 1) may access authentication information stored in the product and share database 210 (FIG. 2C). In embodiments, the authentication information is provided to the firewall 131 (FIG. 1) by the authentication and reporting component 230 (FIG. 2C). In alternative embodiments, the firewall 131 (FIG. 1) routes the authentication request to the authentication and reporting component 230 (FIG. 2C) to authenticate the product owner. The authentication and reporting component 230 (FIG. 2C) can then forward the request back to the firewall 131 (FIG. 1) after a successful authentication.

Upload operation 608 uploads a product. In embodiments, the product owner's appliance 101 (FIG. 1) uploads a product to the product owner server 141 (FIG. 1). The product may be a digital file that is stored on the product and share database 150 (FIG. 1). In embodiments, the product owner uploads two or more products. In embodiments, the product owner's appliance 101 (FIG. 1) interfaces with a user interface 216 (FIG. 2B) to provide inputs regarding the product. The product upload component 220 (FIG. 2B) can receive the product and the terms and conditions of the product's sale and save the product to the product and share database 210 (FIG. 2B).

Set operation 610 set the terms and conditions for a revenue share agreement. In embodiments, the product owner's appliance 101 (FIG. 1) uploads a pre-generated revenue share agreement and stores the revenue share agreement in the product and share database 150 (FIG. 1). In other embodiments, the product owner interfaces with a user interface 216 (FIG. 2B) that produces a web page 303 (FIG. 3). The product owner interfaces with the web page 303 (FIG. 3) to enter information into one or more user interface devices, for example, text box 304 (FIG. 3). The data entered into the web page 303 (FIG. 3) is stored by the user share agreement engine 222 (FIG. 2B) into the product and share database 210 (FIG. 2B). The product owner server 141 (FIG. 1) may then offer the product and the shares associated with the revenue share agreement as a bundled offering. Confirm operation 612 confirms the transaction. In embodiments, the product owner server 141 (FIG. 1) sends a confirmation message (e.g., a change to the web page displayed on the product owner's appliance 101 (FIG. 1).

Receive operation 614 receives a connection from the user. In embodiments, the user begins communication with a user server 140 (FIG. 1) using a user appliance 102 (FIG. 1). The communication may be the request of a web page using a URL. Access operation 616 accesses the network. In embodiments, the user appliance 102 (FIG. 1) communicates with the ISP 115 (FIG. 1) through link 120 (FIG. 1) to connect with the Internet 110 (FIG. 1). The web request is routed to the ISP 125 (FIG. 1) and to the firewall 130 (FIG. 1).

Sign in operation 618 signs in the user. In embodiments, the user and the user appliance 102 (FIG. 1) are authenticated. The firewall 130 (FIG. 1) may access authentication information stored in the product and share database 210 (FIG. 2C). In embodiments, the authentication information is provided to the firewall 130 (FIG. 1) by the authentication and reporting component 230 (FIG. 2C). In alternative embodiments, the firewall 130 (FIG. 1) routes the authentication request to the authentication and reporting component 230 (FIG. 2C) to authenticate the user. The authentication and reporting component 230 (FIG. 2C) can then forward the request back to the firewall 130 (FIG. 1) after a successful authentication.

Conduct operation 620 conducts a transaction between the product owner and the user. In embodiments, the user appliance 102 (FIG. 1) is displayed on a web page 401 (FIG. 4) generated by the user interface 202 (FIG. 2A) to purchase a product. For example, the user may wish to purchase a music download. In embodiments, the user selects a user interface, for example, button 414 (FIG. 4), to purchase a bundled offering. In selecting to purchase a bundled offering, the user both buys the product and enters the revenue share agreement. The user server 102 (FIG. 1) can send the product to the user appliance 102 (FIG. 1), for example, by downloading a digital music file. Further, the user, in embodiments, is given one or more shares in the product. In one embodiment, the user server 102 (FIG. 1) saves the information about the share purchase in the product and share database 210 (FIG. 2A). In another embodiment, the user server 102 (FIG. 1) sends the information to the user appliance 102 (FIG. 1).

Trade operation 622 trades shares. In embodiments, the user selects a button 420 (FIG. 4) to enter a trade exchange as displayed in web page 501 (FIG. 5). The user's owned shares may be displayed in the web page 501 (FIG. 5). The user can select a user interface device 510 (FIG. 5) to sell one or more shares owned by the user. In another embodiment, one or more shares, either owned or not owned by the user is shown in web page 501 (FIG. 5), and the user may purchase shares. The user may select user interface device 508 (FIG. 5) to purchase shares. If selling shares, the user server 102 (FIG. 1) can receive the transaction information and send the information to the banking server 226 (FIG. 2C). The billing and banking component 236 (FIG. 2C) can determine what monetary value the seller should be provided and remit payment using one or more various methods known in the art. If purchasing, the user server 102 (FIG. 1) can receive the transaction information and send the information to the banking server 226 (FIG. 2C), which will determine what monetary value the buyer needs to pay and accept payment using one or more various methods known in the art.

In embodiments, the web page 501 (FIG. 5) shows the share price 506 (FIG. 5) of a share. The share price 506 (FIG. 5), in embodiments, is the current price of the share on the market. The current share price can be determined using one or more methods known in the art of share trading. For example, the current share price may represent the last, highest offer for the share price. Other methods are contemplated, for example, one embodiment might use an algorithm based on the following factors to determine share pricing: number of shares bought or sold in the past hour; number of buyers waiting to purchase a share; number of sellers waiting in a queue to sell a share; and, the amount of time that has passed since the last share was offered for sale on the trading exchange.

Share operation 624 shares revenue. As the product earns revenue through normal distribution channels, revenue from product sales will be shared between the product owner and the one or more users owning product shares based on the terms and conditions of the revenue share agreement established in step 610. In an embodiment, the billing and banking component 236 (FIG. 2C) receives or accesses information (such as from the product and share database 210 (FIG. 2C)) to determine the amount of revenue produced for a product. The billing and banking component 236 (FIG. 2C) may then determine the portion of revenue assigned to the product owner and send that portion to the product owner, possibly, through the product owner's appliance 101 (FIG. 1). The remaining portion may be assigned to the users owning one or more shares of the product. The billing and banking component 236 (FIG. 2C), in embodiments, determines the number of outstanding shares. The billing and banking component 236 (FIG. 2C) divides the remaining portion of the revenue by the number of outstanding shares to determine a dividend per share. Then, in embodiments, the billing and banking component 236 (FIG. 2C) determines an amount of dividend for each user based on how many shares the user owns. This information can be retrieved from the product and share database 210 (FIG. 2C). In embodiments, the billing and banking component 236 (FIG. 2C) sends the dividend to each user's user appliance 102 (FIG. 1).

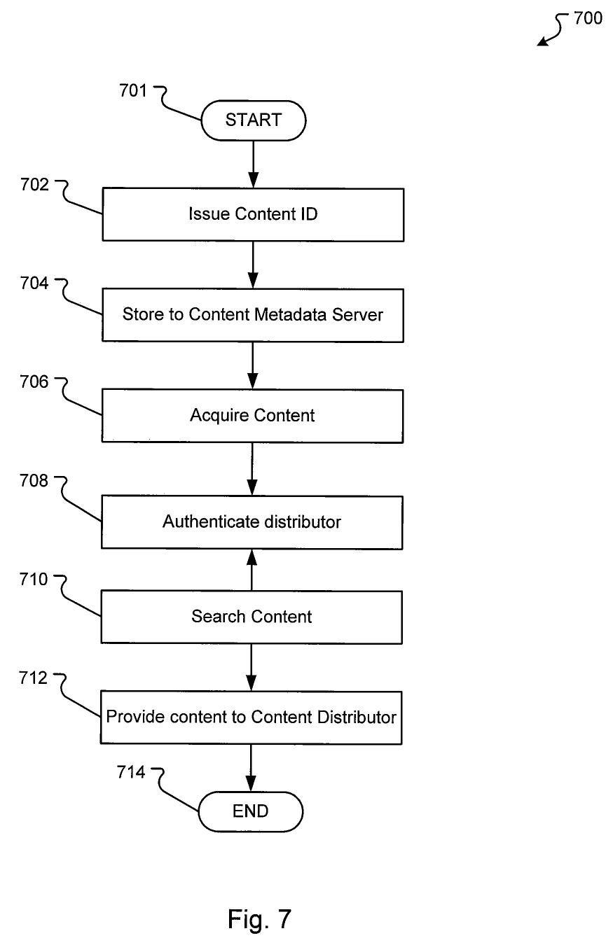

A flow chart of an embodiment of a method 700 for providing content to a content distributor to allow a product transaction, as in operation 620 (FIG. 6), is shown in FIG. 7. The method 700, in embodiments, represents one or more instructions executable in a computer system for directing the computer system to complete an action. The instructions may be stored on a storage medium and retrieved by the computer system. The method 700, in embodiments, begins with a start operation 701 and terminates with an end operation 714. While a specific order is shown in FIG. 7, the steps may be performed in a different order.

Issue operation 702 issues a content identifier (ID). In embodiments, the product upload component 220 (FIG. 2B) creates a unique identifier for each product uploaded from the product owner's appliance 101 (FIG. 1), as explained in operation 608 (FIG. 6). The unique identifier is the content ID and is used to identify the product in the product and share database 210 (FIG. 2B). Store operation 704 stores the content ID. In embodiments, the upload component 220 (FIG. 2B) stores the content ID in the product and share database 210 (FIG. 2B). Acquire operation 706 acquires the content. In embodiments, acquire operation 706 is the same or similar to upload operation 608 as explained in conjunction with FIG. 6. The uploaded product, in embodiments, is assigned the content ID and stored in the product and share database 210 (FIG. 2B) by the product upload component 220 (FIG. 2B).

Authenticate operation 708 authenticates a content distributor. In embodiments, the user server 102 (FIG. 1) is the content distributor. In other embodiments, the content distributor is another server or entity that distributes the content. In embodiments, the user server 102 (FIG. 1) is authenticated. The product owner server 141 (FIG. 1) may access authentication information stored in the product and share database 210 (FIG. 2B). In embodiments, the authentication information is provided to the firewall 130 (FIG. 1) by the authentication and reporting component 230 (FIG. 2C). In alternative embodiments, the firewall 130 (FIG. 1) routes the authentication request to the authentication and reporting component 230 (FIG. 2C) to authenticate the user server 102 (FIG. 1). The authentication and reporting component 230 (FIG. 2C) can then forward the request back to the firewall 130 (FIG. 1) after a successful authentication. A similar process can be conducted for an outside content distributor.

Search operation 710 searches content. In embodiments, a content distributor, for example, the user server 102 (FIG. 1), searches the product and share database 210 (FIG. 2A) to find content. The search may be conducted as part of a user session on the user server 102 (FIG. 1). Provide operation 712 provides content to the content distributor. In embodiments, any selected content can be identified in the product and share database 210 (FIG. 2B) by the content ID and sent to the content distributor. The product owner server 141 (FIG. 1) can track the transmissions to the content distributors, revenue and information sent from the content distributors about content, and other transactions by the content ID.

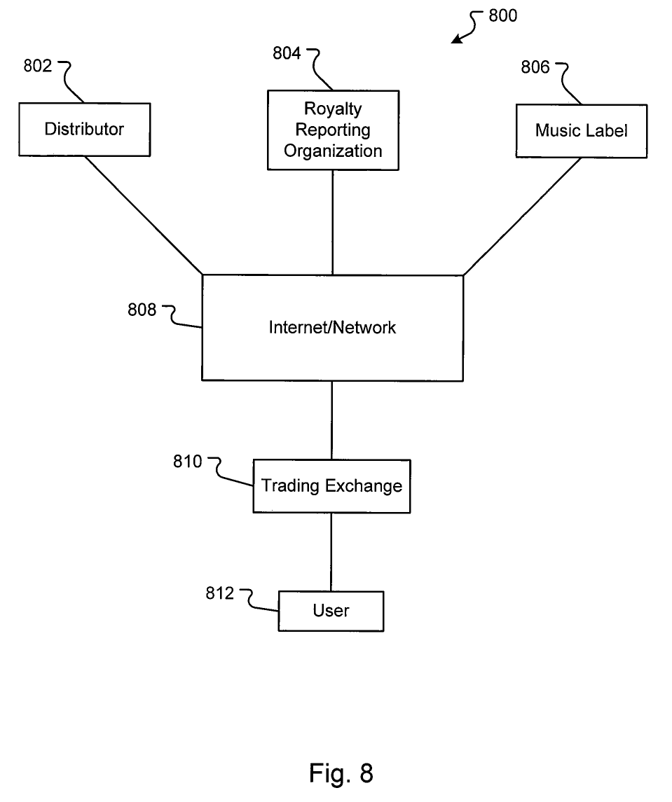

An embodiment of a business intelligence system 800 is shown in FIG. 8. In embodiments, an Internet or network 808 communicates with one or more of a content distributor 802, a royalty reporting organization 804, a music label 806, and/or a user 812, through the trading exchange 810. Each entity may include one or more computer systems operable to communicate through the network 808. The network 808 may be the same or similar to network 110 (FIG. 1). A content distributor 802 is the same or similar to the content distributor explained in conjunction with FIG. 7. The trading exchange 810 is the same or similar to the exchange explained in conjunction with FIG. 2B and FIG. 5.

The royalty reporting organization 804 can be an outside organization that reports and provides the royalty revenue to the banking and billing component 236 (FIG. 2C). The royalty reporting organization 804, in embodiments, receives the royalties from one or more sources, for example, online sales, CD purchases from music stores, radio play, etc. The music label 806, in embodiments, is the business or organization that produces the product or content. In embodiments, the music label 806 is the same or similar to the product owner.

The business intelligence component 234 (FIG. 2C) can communicate with the network 808 to extract, collect and/or input data into the trading exchange 810 from the multiple sources, for example, the content distributor 802, the royalty reporting organization 804, or the music label 806. The business intelligence component 234 (FIG. 2C) can receive information on sales, revenues, volume of sales, share trades, etc. to create published business intelligence reports, as explained in conjunction with FIG. 2C. The user 812 can use the business intelligence reports and information to make informed purchasing decisions for products and shares.

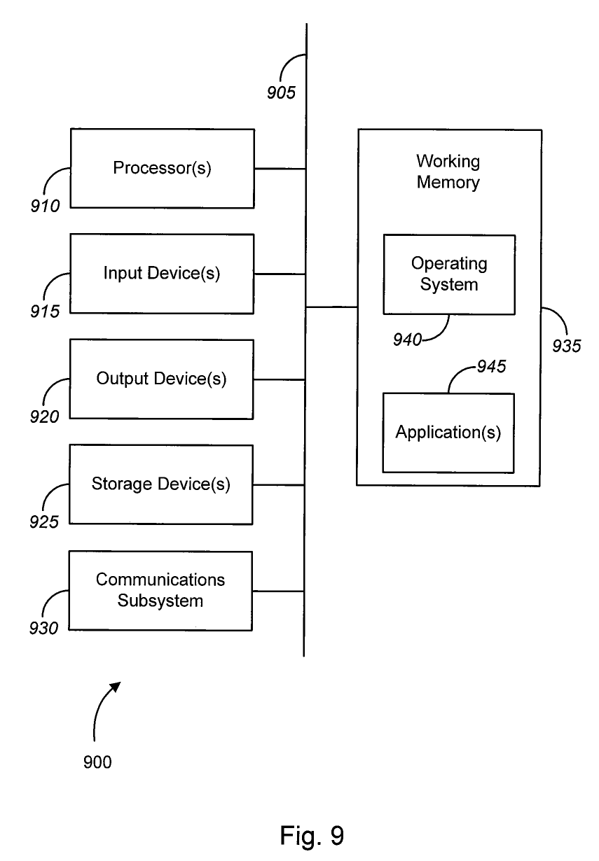

FIG. 9 provides a schematic illustration of one embodiment of a computer system 900 that can perform the methods of the invention, as described herein, and/or can function as a client information appliance, a server, and/or the like. It should be noted that FIG. 9 is meant only to provide a generalized illustration of various components, any or all of which may be utilized as appropriate. FIG. 9, therefore, broadly illustrates how individual system elements may be implemented in a relatively separated or relatively more integrated manner.

The computer system 900 is shown comprising hardware elements that can be electrically coupled via a bus 905 (or may otherwise be in communication, as appropriate). The hardware elements can include one or more processors 910, including without limitation one or more general-purpose processors and/or one or more special-purpose processors (such as digital signal processing chips, graphics acceleration chips, and/or the like); one or more input devices 915, which can include without limitation a mouse, a keyboard and/or the like; and one or more output devices 920, which can include without limitation a display device, a printer and/or the like.

The computer system 900 may further include (and/or be in communication with) one or more storage devices 925, which can comprise, without limitation, local and/or network accessible storage and/or can include, without limitation, a disk drive, a drive array, an optical storage device, solid-state storage device such as a random access memory (“RAM”) and/or a read-only memory (“ROM”), which can be programmable, flash-updateable and/or the like. The computer system 900 might also include a communications subsystem 930, which can include without limitation a modem, a network card (wireless or wired), an infra-red communication device, a wireless communication device and/or chipset (such as a Bluetooth™ device, an 902.11 device, a WiFi™ device, a WiMax device, cellular communication facilities, etc.), and/or the like. The communications subsystem 930 may permit data to be exchanged with a network (such as the network described below, to name one example), and/or any other devices described herein. In many embodiments, the computer system 900 will further comprise a working memory 935, which can include a RAM or ROM device, as described above.

The computer system 900 also can comprise software elements, shown as being currently located within the working memory 935, including an operating system 940 and/or other code, such as one or more application programs 945, which may comprise computer programs of the invention, and/or may be designed to implement methods of the invention and/or configure systems of the invention, as described herein. Merely by way of example, one or more procedures described with respect to the method(s) discussed above might be implemented as code and/or instructions executable by a computer (and/or a processor within a computer). A set of these instructions and/or code might be stored on a computer-readable storage medium, such as the storage device(s) 925 described above. In some cases, the storage medium might be incorporated within a computer system, such as the system 900. In other embodiments, the storage medium might be separate from a computer system (i.e., a removable medium, such as a compact disc, etc.), and/or provided in an installation package, such that the storage medium can be used to program a general purpose computer with the instructions/code stored thereon. These instructions might take the form of executable code, which is executable by the computer system 900 and/or might take the form of source and/or installable code, which, upon compilation and/or installation on the computer system 900 (e.g., using any of a variety of generally available compilers, installation programs, compression/decompression utilities, etc.) then takes the form of executable code.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

In one aspect, the invention employs a computer system (such as the computer system 900) to perform methods of the invention. According to a set of embodiments, some or all of the procedures of such methods are performed by the computer system 900 in response to processor 910 executing one or more sequences of one or more instructions (which might be incorporated into the operating system 940 and/or other code, such as an application program 945) contained in the working memory 935. Such instructions may be read into the working memory 935 from another machine-readable medium, such as one or more of the storage device(s) 925. Merely by way of example, execution of the sequences of instructions contained in the working memory 935 might cause the processor(s) 910 to perform one or more procedures of the methods described herein.

The terms “machine-readable medium” and “computer-readable medium,” as used herein, refer to any medium that participates in providing data that causes a machine to operate in a specific fashion. In an embodiment implemented using the computer system 900, various machine-readable media might be involved in providing instructions/code to processor(s) 910 for execution and/or might be used to store and/or carry such instructions/code (e.g., as signals). In many implementations, a computer-readable medium is a physical and/or tangible storage medium. Such a medium may take many forms, including but not limited to, non-volatile media, volatile media, and transmission media. Non-volatile media includes, for example, optical or magnetic disks, such as the storage device(s) 925. Volatile media includes, without limitation dynamic memory, such as the working memory 935. Transmission media includes coaxial cables, copper wire and fiber optics, including the wires that comprise the bus 905, as well as the various components of the communication subsystem 930 (and/or the media by which the communications subsystem 930 provides communication with other devices). Hence, transmission media can also take the form of waves (including without limitation radio, acoustic and/or light waves, such as those generated during radio-wave and infra-red data communications).

Common forms of physical and/or tangible computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, an EPROM, a FLASH-EPROM, any other memory chip or cartridge, a carrier wave as described hereinafter, or any other medium from which a computer can read instructions and/or code.

Various forms of machine-readable media may be involved in carrying one or more sequences of one or more instructions to the processor(s) 910 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 900. These signals, which might be in the form of electromagnetic signals, acoustic signals, optical signals and/or the like, are all examples of carrier waves on which instructions can be encoded, in accordance with various embodiments of the invention.

The communications subsystem 930 (and/or components thereof) generally will receive the signals, and the bus 905 then might carry the signals (and/or the data, instructions, etc. carried by the signals) to the working memory 935, from which the processor(s) 910 retrieves and executes the instructions. The instructions received by the working memory 935 may optionally be stored on a storage device 925 either before or after execution by the processor(s) 910.

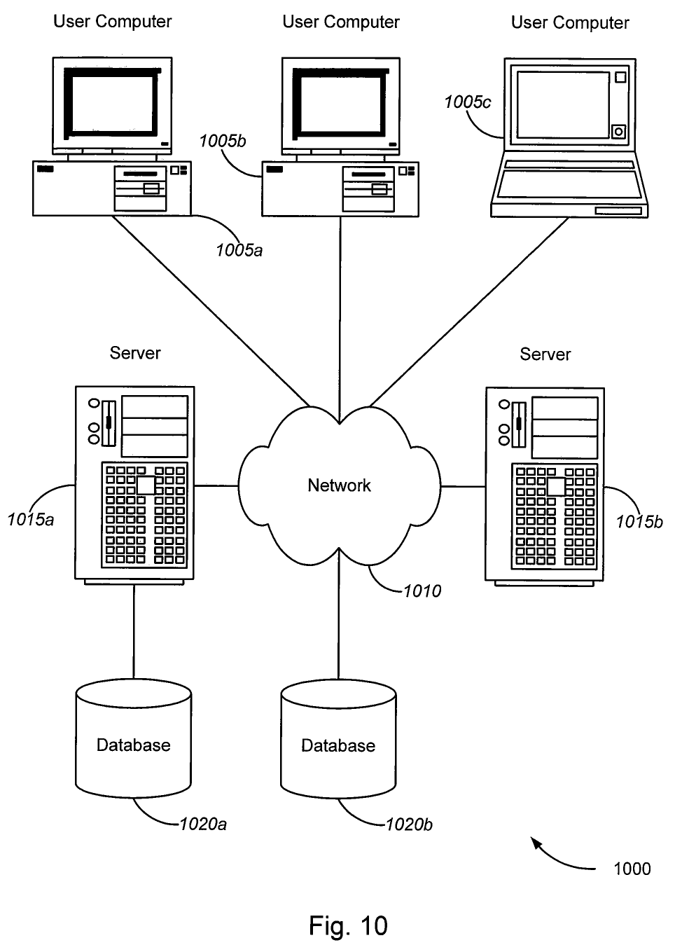

As described above, a set of embodiments comprises systems for online trading. Merely by way of example, FIG. 10 illustrates a schematic diagram of a system 1000 that can be used in accordance with one set of embodiments. The system 1000 can include one or more user computers 1005. The user computers 1005 can be general purpose personal computers (including, merely by way of example, personal computers and/or laptop computers running any appropriate flavor of Microsoft Corp.'s Windows™ and/or Apple Corp.'s Macintosh™ operating systems) and/or workstation computers running any of a variety of commercially-available UNIX™ or UNIX-like operating systems. These user computers 1005 can also have any of a variety of applications, including one or more applications configured to perform methods of the invention, as well as one or more office applications, database client and/or server applications, and web browser applications. Alternatively, the user computers 1005 can be any other electronic device, such as a thin-client computer, Internet-enabled mobile telephone, and/or personal digital assistant, capable of communicating via a network (e.g., the network 1010 described below) and/or displaying and navigating web pages or other types of electronic documents. Although the exemplary system 1000 is shown with three user computers 1005, any number of user computers can be supported.

Certain embodiments of the invention operate in a networked environment, which can include a network 1010. The network 1010 can be any type of network familiar to those skilled in the art that can support data communications using any of a variety of commercially-available protocols, including without limitation TCP/IP, SNA, IPX, AppleTalk, and the like. Merely by way of example, the network 1010 can be a local area network (“LAN”), including without limitation an Ethernet network, a Token-Ring network and/or the like; a wide-area network; a virtual network, including without limitation a virtual private network (“VPN”); the Internet; an intranet; an extranet; a public switched telephone network (“PSTN”); an infra-red network; a wireless network, including without limitation a network operating under any of the IEEE 802.11 suite of protocols, the Bluetooth™ protocol known in the art, and/or any other wireless protocol; and/or any combination of these and/or other networks.

Embodiments of the invention can include one or more server computers 1015. Each of the server computers 1015 may be configured with an operating system, including without limitation any of those discussed above, as well as any commercially (or freely) available server operating systems. Each of the servers 1015 may also be running one or more applications, which can be configured to provide services to one or more clients 1005 and/or other servers 1015.

Merely by way of example, one of the servers 1015 may be a web server, which can be used, merely by way of example, to process requests for web pages or other electronic documents from user computers 1005. The web server can also run a variety of server applications, including HTTP servers, FTP servers, CGI servers, database servers, Java servers, and the like. In some embodiments of the invention, the web server may be configured to serve web pages that can be operated within a web browser on one or more of the user computers 1005 to perform methods of the invention.

The server computers 1015, in some embodiments, might include one or more application servers, which can include one or more applications accessible by a client running on one or more of the client computers 1005 and/or other servers 1015. Merely by way of example, the server(s) 1015 can be one or more general purpose computers capable of executing programs or scripts in response to the user computers 1005 and/or other servers 1015, including without limitation web applications (which might, in some cases, be configured to perform methods of the invention). Merely by way of example, a web application can be implemented as one or more scripts or programs written in any suitable programming language, such as Java™, C, C#™ or C++, and/or any scripting language, such as Perl, Python, or TCL, as well as combinations of any programming/scripting languages. The application server(s) can also include database servers, including without limitation those commercially available from Oracle, Microsoft, Sybase™, IBM™ and the like, which can process requests from clients (including, depending on the configuration, database clients, API clients, web browsers, etc.) running on a user computer 1005 and/or another server 1015. In some embodiments, an application server can create web pages dynamically for displaying the information in accordance with embodiments of the invention, such as the web pages described above. Data provided by an application server may be formatted as web pages (comprising HTML, Javascript, etc., for example) and/or may be forwarded to a user computer 1005 via a web server (as described above, for example). Similarly, a web server might receive web page requests and/or input data from a user computer 1005 and/or forward the web page requests and/or input data to an application server. In some cases a web server may be integrated with an application server.

In accordance with further embodiments, one or more servers 1015 can function as a file server and/or can include one or more of the files (e.g., application code, data files, etc.) necessary to implement methods of the invention incorporated by an application running on a user computer 1005 and/or another server 1015. Alternatively, as those skilled in the art will appreciate, a file server can include all necessary files, allowing such an application to be invoked remotely by a user computer 1005 and/or server 1015. It should be noted that the functions described with respect to various servers herein (e.g., application server, database server, web server, file server, etc.) can be performed by a single server and/or a plurality of specialized servers, depending on implementation-specific needs and parameters.

In certain embodiments, the system can include one or more databases 1020. The location of the database(s) 1020 is discretionary: merely by way of example, a database 1020a might reside on a storage medium local to (and/or resident in) a server 1015a (and/or a user computer 1005). Alternatively, a database 1020b can be remote from any or all of the computers 1005, 1015, so long as the database 1020b can be in communication (e.g., via the network 1010) with one or more of these. In a particular set of embodiments, a database 1020 can reside in a storage-area network (“SAN”) familiar to those skilled in the art. (Likewise, any necessary files for performing the functions attributed to the computers 1005, 1015 can be stored locally on the respective computer and/or remotely, as appropriate.) In one set of embodiments, the database(s) 1020 can be relational databases, such as Oracle databases, that are adapted to store, update, and retrieve data in response to SQL-formatted commands. The databases 1020 might be controlled and/or maintained by a database server, as described above, for example.

While the invention has been described with respect to exemplary embodiments, one skilled in the art will recognize that numerous modifications are possible. For example, the methods and processes described herein may be implemented using hardware components, software components, and/or any combination thereof. Further, while various methods and processes described herein may be described with respect to particular structural and/or functional components for ease of description, methods of the invention are not limited to any particular structural and/or functional architecture but instead can be implemented on any suitable hardware, firmware and/or software configuration. Similarly, while various functionality is ascribed to certain system components, unless the context dictates otherwise, this functionality can be distributed among various other system components in accordance with different embodiments of the invention.

Moreover, while the procedures comprised in the methods and processes described herein are described in a particular order for ease of description, unless the context dictates otherwise, various procedures may be reordered, added, and/or omitted in accordance with various embodiments of the invention. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments are described with—or without—certain features for ease of description and to illustrate exemplary features, the various components and/or features described herein with respect to a particular embodiment can be substituted, added and/or subtracted from among other described embodiments, unless the context dictates otherwise. Consequently, although the invention has been described with respect to exemplary embodiments, it will be appreciated that the invention is intended to cover all modifications and equivalents within the scope of the following claims.

Some alternative embodiments provide modifications and changes to the trading systems and methods. For example, while digital products can be input into the system through an upload management system for digital products, non-digital products may still be sold and can either be shipped to a physical address for redistribution or drop shipped directly to customers. In other embodiments, a custom database with a custom interface may be used instead of web pages. Thus, the trading exchange may be a closed system. In still further embodiments, the trading may occur with brokers or intermediaries that receive, sell, or buy orders from customers.

There is currently no open trading exchange platform that offers the ability to trade in investments in products, or product concepts, and shares in revenues from a class of products, or product concepts. The absence of such a trading platform hinders innovation and creativity across industries because funding for new product creation, development, marketing, and distribution is limited to loan financing, high interest venture capital funding, and/or or the sale of shares in a company. Embodiments presented herein can allow for the purchase of shares in the product, as opposed to the company making or marketing the product. A product share can be purchased using the trading exchange. The purchaser, in embodiments, then has an interest in the sales and future valuation of the product. As such, companies could generate funding for product launches without ceding shares of the company or obtaining expensive financing.

Several advantages of the described embodiments are readily apparent. For example, selling the bundled offerings allow users to potentially profit from future share dividend payments and share price increases of the products. Further, the users that participate in and profit from the product sales that have traditionally been closed to the general public are encouraged to avoid purchasing products illegally. The users that trade illegally downloaded music will risk disbarment and/or other punitive actions for engaging in such behavior. Embodiments allow users to participate in a social networking system, which ensure viral marketing of new product releases and benefit product owners from a marketing perspective. Further, the system provides business intelligence by extracting, collecting and/or inputting data from multiple sources, such as record labels, royalty collecting organizations, music distributors, etc. in all formats and then to create published business intelligence reports. Thus, the system can provide the up-to-date information to users to make trading decisions based on accurate market data.

Advantageously, embodiments of the global net-work based trading exchange presented herein provide the ability to trade in investments in the products or product concepts. The purchaser can share in revenues from a class of products or product concepts that traditionally have not been offered and traded on an open trading exchange platforms in two locations. The global net-work based trading exchange used for trading shares in products or product offerings can act as an incentive for innovation and creativity across industries where the funding for new product creation, development, marketing, and distribution has relied on other sources.

Another advantage of embodiments presented herein is that the ownership interest of the investor can be limited to a specific product or product concept, rather than in shares of an actual company. Thus, the global net-work based trading exchange allows for external investment but allows the owners of the company to retain interest in the company. The global net-work based trading exchange and methods described herein provide easily accessed investment for new products and product concepts. In particular, the investment in product or product concept offerings can benefit start-up companies and independent inventors. These entities have had a difficult time raising capital or have had to raise capital from angel investment and/or venture capital (VC) funding. For both start-up companies and independent inventors, using angel investment and/or venture capital (VC) funding may require the relinquishment of a disproportionate share of ownership in the company. The global net-work based trading exchange can greatly expand market choice and investment sources. For example, when trading in investments in product concepts, the trading exchange is able to facilitate the needs of young companies, start-ups, and inventors looking to replace investment from angel investment and/or VC funding.

The tools provided by various embodiments include, without limitation, methods, systems, and/or software products. Mainly by way of example, a method might comprise one or more procedures, any or all of which are executed by a computer system. Correspondingly, an embodiment might comprise a computer system configured with instructions to perform one or more procedures in accordance with methods of the invention. Similarly, a computer program might comprise a set of instructions that are executable by a computer system (and/or a processor therein) to perform such operations. In many cases, such software programs are encoded on physical and/or tangible computer-readable media (such as, merely by way of example, optical media, magnetic media, and/or the like).

What is claimed is:

1. A network-based trading exchange system, comprising:
a processor; and
a computer-readable medium in communication with the processor, the computer-readable medium having encoded thereon a set of instructions executable by the processor to perform a method, the set of instructions comprising:
instructions for receiving a product from a product owner to be sampled, sold and traded on a global network-based trading exchange;
instructions for receiving a revenue share agreement, from the product owner, associated with the product;
instructions for offering the product and one or more shares associated with the revenue share agreement as a bundled offering;
instructions for receiving one or more offers to purchase the bundled offering from one or more users, wherein the purchase of the bundled offering includes an acceptance of the revenue share agreement;
instructions for determining a price for the bundled offering; and
instructions for selling the bundled offering for the determined price.

2. The system as defined in claim 1, wherein the product is a creative product.

3. The system as defined in claim 2, wherein the creative product is a downloadable music file.

4. The system as defined in claim 2, wherein the creative product is one of a group consisting of a music stream, a CD, a DVD, a ringtone, and a concert ticket.

5. The system as defined in claim 1, wherein determining a price for the bundled offering comprises:
instructions for reading a formula associated with the bundled offering; and
instructions for executing the formula to determine the price per share for the one or more shares associated with the revenue share agreement.

6. The system as defined in claim 1, wherein the price is determined by an auction system.

7. The system as defined in claim 1, wherein the product owner is one of a group consisting of a music label, an independent artist, a content owner, and a distributor of creative products.

8. The system as defined in claim 1, wherein instructions for receiving a revenue share agreement comprises instructions for receiving terms and conditions associated with the bundled offering.

9. The system as defined in claim 8, wherein the terms and conditions comprise an effective start date of the revenue share agreement, an effective end date of the revenue share agreement, a list price for the product, a list price for a share in the product, a number of available shares, and an amount of revenue to be shared between a user and a product owner.

10. The system as defined in claim 1, further comprising:
instructions for creating a prospectus, wherein the prospectus is based on data input by the product owner; and
instructions for providing the prospectus to the one or more users, wherein the one or more users may evaluate the revenue share agreement and the value of the one or more shares with the prospectus.

11. The system as defined in claim 1, further comprising:
instructions for receiving revenue from the sale of the bundled offering;
instructions for determining a portion of the received revenue owned by the product owner;
instructions for determining one or more portions of the received revenue owned by the one or more users;
instructions for providing the determined portion of received revenue to the product owner; and
instructions for providing, to each of the one or more users, the determined portion of received revenue owned by the user.

12. A method of using a global music stock exchange comprising:
receiving a downloadable music product from a product owner to be sampled, sold and traded on a global network-based trading exchange;
receiving a revenue share agreement, from the downloadable music product owner, associated with the downloadable music product;
offering the downloadable music product and one or more shares associated with the revenue share agreement as a bundled offering;
receiving one or more offers to purchase the bundled offering from one or more users, wherein the purchase of the bundled offering includes an acceptance of the revenue share agreement;
determining a price for the bundled offering;
selling the bundled offering for the determined price;
receiving one or more shares to sell on the global music stock exchange;
determining a price for each of the one or more shares;
receiving an offer to purchase one or more shares for the determined price; and
selling the one or more shares at the determined price.

13. The method as defined in claim 12, further comprising:
determining a dividend payment for each of the one or more shares; and
providing a dividend to each of the one or more users that own one or more shares.

14. The method as defined in claim 13, wherein the dividend is equal to the dividend multiplied by a number of shares owned by the user.

15. The method as defined in claim 12, further comprising matching a first offer to purchase one or more shares with a first one or more shares offered for sale.

16. The method as defined in claim 12, further comprising detecting one or more unauthorized trades of the downloadable music product made by a first user;
revoking the one or more shares owned by the first; and
preventing the first user from participating in a future purchase or a future sale.

17. The method as defined in claim 12, further comprising:
creating an account for each of the one or more users;
providing, in the account, a number of shares owned for one or more products purchased by the user;
providing, in the account, one or more monetary values for one or more shares owned by the user; and
providing, in the account, one or more monetary values for a projected dividend for one or more shares owned by the user.

18. The method as defined in claim 12, further comprising:
collecting data from one or more information sources to create a business intelligence report, wherein the one or more information sources include one or more of a record label, a royalty collecting organization, or a music distributor; and
publishing the business intelligence report to the one or more users, wherein the business intelligence report provides a reporting of revenue share dividends to product owners and users.

19. A global product stock exchange, comprising:
a network, the network operable to communicate data;
a product owner server in communication with the network, the product owner server operable to provide a first user interface for a product owner to upload a downloadable product to the product owner server, to upload a revenue share agreement associated with the downloadable product, the product owner server operable to offer the downloadable product and one or more shares associated with the revenue share agreement as a bundled offering; and
a user server in communication with the network, the user server operable to provide a user interface to the user to purchase the bundled offering, the user server operable to receive an offer to purchase the bundled offering, the user server operable to receive payment for the bundled offering; and the user server operable to provide the downloadable product to the user and operable to provide the one or more shares to the user.

20. The global product stock exchange as defined in claim 19, further comprising a banking server in communication with the network, the banking server operable to receive the payment from the user server, the banking server operable to determine a first portion of the payment owned by the product owner and a second portion of the payment owned by one or more share owners, the banking server operable to distribute the first portion to the product owner and distribute one or more second portions to one or more share owners.
